(19) United States
(12) Patent Application Publication
(10) Pub. No.: US 2005/0226994 A1
(43) Pub. Date: Oct. 13, 2005

(54) Controlling making microcavity OLED devices

(75) Inventor: Yuan-Sheng Tyan, Webster, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/819,696

(22) Filed: Apr. 7, 2004

(51) Int. Cl. B05D 5/06; B05D 5/12

(52) U.S. Cl. 427/66

(57) ABSTRACT

A method for controlling the fabrication of microcavity OLED device includes providing a substrate, forming a microcavity OLED device including two mirror layers and one or more organic layers disposed between the two mirror layers, and illuminating the microcavity OLED device and measuring the reflectivity spectrum to determine the wavelength of the reflectivity minimum. The method also includes comparing the wavelength of the reflectivity minimum to a target value to produce an difference signal, and making adjustments in accordance with the difference signal to the deposition rate or deposition time of at least one of the organic layers in a subsequent OLED device to reduce the difference signal in the subsequent microcavity OLED device.

### CROSS REFERENCE TO RELATED APPLICATIONS

Reference is made to commonly assigned U.S. patent application Ser. No. 10/346,424 filed Jan. 17, 2003 entitled “Microcavity OLED Devices” by Yuan-Sheng Tyan et al.; commonly assigned U.S. patent application Ser. No. 10/368,513 filed Feb. 18, 2003 entitled “Tuned Microcavity Color OLED Display” by Yuan-Sheng Tyan et al.; and commonly assigned U.S. patent application Ser. No. 10/356,271 filed Jan. 31, 2003 entitled “Color OLED Display with Improved Emission” by Yuan-Sheng Tyan et al., the disclosures of which are herein incorporated by reference.

### FIELD OF INVENTION

The present invention relates to a method for controlling the making of tuned microcavity OLED display devices.

### BACKGROUND OF INVENTION

Full color organic electroluminescent (EL), also known as organic light-emitting devices or OLED, have recently been demonstrated as a new type of flat panel display. In simplest form, an organic EL device is comprised of an electrode serving as the anode for hole injection, an electrode serving as the cathode for electron injection, and an organic EL element sandwiched between these electrodes to support charge recombination that yields emission of light. An example of an organic EL device is described in U.S. Pat. No. 4,356,429. In order to construct a pixilated display device such as is useful, for example, as a television, computer monitor, cell phone display or digital camera display, individual organic EL elements can be arranged as an array of pixels in a matrix pattern. To produce a multicolor display, the pixels are further arranged into subpixels, with each subpixel emitting a different color. This matrix of pixels can be electrically driven using either a simple passive matrix or an active matrix driving scheme. In a passive matrix, the organic EL element is sandwiched between two sets of orthogonal electrodes arranged in rows and columns. An example of a passive matrix driven organic EL devices is disclosed in U.S. Pat. No. 5,276,380. In an active matrix configuration, each pixel is driven by multiple circuit elements such as transistors, capacitors, and signal lines. Examples of such active matrix organic EL devices are provided in U.S. Pat. Nos. 5,550,066, 6,281,634, and 6,456,013.

In an OLED device, the preparation of the organic layers must be accurately controlled in order to achieve the desired properties of the OLED device such as operating voltage, efficiency, and color. One control technique commonly used for OLED devices that are deposited by evaporation is the use of crystal mass sensor device (also referred to as a quartz oscillator) over the deposition sources to monitor deposition thickness at a location near the substrate. The crystal mass sensor is calibrated to relate the mass of the material deposited onto the sensor to a layer thickness on the device substrate. This technique, however, has the disadvantage in that the crystal mass sensor will have a large film build-up in a high volume mass production environment, which can alter the calibration over time and require frequent changing. Another disadvantage is that the crystal mass sensor is located outside the area of the device and therefore must be calibrated to relate to the deposition on the substrate that is in a physically different location. In some deposition systems, such a those which are constructed with a thermal evaporation source, the uniformity of the deposition in the chamber can vary over time, such as when the amount of organic material in the source is depleted. Therefore this technique has the inherent disadvantage of not being able to measure the actual films being deposited on the substrate.

Another method of monitoring the layer thickness proposed in U.S. Pat. No. 6,513,451 is to use an optical measurement system such as an interferometer or spectrophotometer to measure the thickness on a moving member which is in the path of the deposition. The moving member can be, for example, a disc which is rotated or indexed so that the surface is also refreshed to avoid layer build up or to permit the measurement of an individual layer. The member can also be cleaned to permit for improved uptime. This method, however, still has the problem that the measurement device is outside the area of the substrate and requires cross calibration that can vary over time. Inaccuracy of the calibration can result in the thickness of the film being different in the target that might result in sub-optimal device characteristics or manufacturing yield loss. Device characteristics, which might suffer from the film being deposited off target include, for example, emission color, efficiency, and device lifetime.

The measuring and controlling the film preparation process is particular critical when an OLED device utilizing a microcavity structure is being fabricated. In a microcavity OLED device the organic EL medium structure is disposed between two highly reflecting mirrors, one of which is light transmissive. The reflecting mirrors form a Fabry-Perot microcavity that strongly modifies the emission properties of the organic EL medium structure disposed in the microcavity. Emission near the wavelength corresponding to the resonance wavelength of the cavity is enhanced and those with other wavelengths are suppressed. The use of a microcavity in an OLED device has been shown to reduce the emission bandwidth and improve the color purity, or chromaticity, of emission (U.S. Pat. No. 6,326,224 B1; Yokoyama, Science, Vol. 256, p66, 1992; Jordan et al. Appl. Phys. Lett. 69, p1997, 1996). The emission efficiency at least at the normal direction is also greatly improved. Although OLED devices utilizing microcavity structures offer attractive performance advantages, however, the fabrication of these devices is difficult. The emission characteristics and performance of a microcavity OLED device are extremely sensitive to small variations in the cavity length which is defined by the total optical thickness of all layers between the two reflecting mirrors. As will be shown later in the application, even a small change in the thickness of these layers can cause a large change in the emission color and intensity of the device. Conventional monitoring devices described above do not have the accuracy and precision needed to control the manufacturing tolerance required to fabricate microcavity OLED devices. Although the discussion above focused on small molecular OLED devices fabricated by vapor deposition processes, similar film preparation measurement and control concerns apply also to polymer based OLED's (PLEDs) fabricated by spin coating, inkjet coating, or other solution based fabrication processes.

### SUMMARY OF THE INVENTION

It is therefore an object of the present invention to provide an improved measurement-control method for the fabrication of microcavity OLED devices.

This object is achieved by a method for controlling the fabrication of microcavity OLED device, comprising:
a) providing a substrate;
b) forming a microcavity OLED device including two mirror layers and one or more organic layers disposed between the two mirror layers;
c) illuminating the microcavity OLED device and measuring the reflectivity spectrum to determine the wavelength of the reflectivity minimum;
d) comparing the wavelength of the reflectivity minimum to a target value to produce an difference signal; and
e) making adjustments in accordance with the difference signal to the deposition rate or deposition time of at least one of the organic layers in a subsequent OLED device to reduce the difference signal in the subsequent microcavity OLED device.

### BRIEF DESCRIPTION OF THE DRAWINGS

FIG. 1 is a schematic cross-sectional view of a microcavity OLED device;

FIG. 2 shows the variation of resonance emission wavelength as a function of NPB thickness in a microcavity OLED device;

FIG. 3 shows the change in emission spectrum when the NPB thickness is changed;

FIG. 4 shows the change in emission spectrum when the NPB thickness and Alq thickness are both changed to maintain a constant total thickness;

FIG. 5A shows the reflectivity and emission spectra of a microcavity OLED device tuned for blue emission;

FIG. 5B shows the reflectivity and emission spectra of a microcavity OLED device tuned for green emission;

FIG. 5C shows the reflectivity and emission spectra of a microcavity OLED device tuned for red emission;

FIG. 6 shows the relationship between Rₘᵢₙ and Eₘₐₓ; and

FIG. 7 shows a manufacturing control process in accordance with the present invention.

### DETAILED DESCRIPTION OF THE INVENTION

The term “display” or “display panel” is employed to designate a screen capable of electronically displaying video images or text. The term “pixel” is employed in its art recognized usage to designate an area of a display panel that can be stimulated to emit light independently of other areas. The term “OLED display device” is used in its art recognized meaning of a display device including organic light-emitting diodes as pixels. A colored OLED display device emits light of at least one color. The term “multicolor” is employed to describe a display panel that is capable of emitting light of a different hue in different areas. In particular, it is employed to describe a display panel that is capable of displaying images of different colors. These areas are not necessarily contiguous. The term “full color” is employed to describe multicolor display panels that are capable of emitting in the red, green, and blue regions of the visible spectrum and displaying images in any hue or combination of hues. The red, green, and blue colors constitute the three primary colors from which all other colors can be produced by appropriately mixing these three primaries. The term “hue” refers to the intensity profile of light emission within the visible spectrum, with different hues exhibiting visually discernible differences in color. The pixel or subpixel is generally used to designate the smallest addressable unit in a display panel. For a monochrome display, there is no distinction between pixel or subpixel. The term “subpixel” is used in multicolor display panels and is employed to designate any portion of a pixel, which can be independently addressable to emit light of a specific color. For example, a blue subpixel is that portion of a pixel, which can be addressed to emit blue light. In a full color display, a pixel generally includes three primary-color subpixels, namely blue, green, and red. For the purposes of the present invention, the terms “pixel” and “subpixel” will be used interchangeably. The term “pitch” is used to designate the distance separating two pixels or subpixels in a display panel. Thus, a subpixel pitch means the separation between two subpixels.

The term “microcavity OLED device” is used to designate an OLED device including an organic EL element having one or more function layers disposed between two reflecting mirrors. Preferably, the anode and the cathode of the OLED device also serve as the two reflecting mirrors. The terms electrode and mirror will be used interchangeably. It is understood, however, that one or both of the electrodes can be transparent, and a separate reflecting mirror can be used behind such a transparent electrode to form the microcavity structure. Preferably, one of the electrodes is essentially opaque and the other one is semitransparent having an optical density less than 1.0. The organic EL element can emit light under applied voltage during the operation of the OLED device. The light is emitted through the semitransparent electrode, which is called the light-emitting electrode. The organic EL element can include one or more organic layers and it can include inorganic layers as well. The two reflecting electrodes form a Fabry-Perot microcavity that strongly affects the emission characteristics of the OLED device. Emission near the wavelength corresponding to the resonance wavelength of the cavity is enhanced and those with other wavelengths are suppressed. The net result is a significant narrowing of the bandwidth of the emitted light and a significant enhancement of its intensity in the normal direction. A microcavity structure behaves like a narrow band amplifier for the emission from the organic EL element.

A microcavity structure can be constructed using a narrow band emitting organic EL element. In this case the resonance wavelength is designed to coincide or nearly coincide with the peak emission wavelength of the organic EL element. When properly constructed, a microcavity OLED device can provide improved luminance efficiency and improved color when compared with non-microcavity OLED devices utilizing similar organic EL elements, commonly assigned U.S. patent application Ser. No. 10/368,513 filed Feb. 18, 2003 entitled “Tuned Microcavity Color OLED Display” by Yuan-Sheng Tyan et al., and commonly assigned U.S. patent application Ser. No. 10/347,013 filed Jan. 17, 2003 entitled “Organic Light-Emitting Diode (OLED) Display With Improved Light Emission Using a Metallic Anode” by Pranab K. Raychaudhuri et al., the disclosures of which are herein incorporated by reference. Alternatively, a microcavity structure can be constructed using a broadband emitting organic EL element. In this case different colored emission can be achieved by tuning the microcavity to have different resonance wavelengths. This method can be used for pixelation to achieve a full color display, commonly assigned U.S. patent application Ser. No. 10/356,271 filed Jan. 31, 2003 entitled “Color OLED Display with Improved Emission” by Yuan-Sheng Tyan et al., the disclosure of which is herein incorporated by reference. The resonance wavelength is thus an important property of a microcavity based OLED device.

The resonance condition of a microcavity device can be described as:
2ΣnᵢLᵢ+(Qₘ₁+Qₘ₂)λ/2Σ=mλ Equation 1
wherein:
nᵢ is the index of refraction and Lᵢ is the thickness of the ith sublayer in organic EL element structure;
Qₘ₁ and Qₘ₂ are the phase shifts in radians at the two organic EL medium structure/reflecting mirror interfaces, respectively;
λ is the resonant wavelength emitted from the device; and
m is a non-negative integer.
   The emission wavelength is thus very sensitive to a change of optical path length between the two reflecting mirrors.

To illustrate the tightened manufacturing requirement and to illustrate the effectiveness of the present invention, theoretical calculations were performed on some model OLED structures. For these calculations, the electroluminescence (EL) spectrum produced by an OLED device is predicted using an optical model that solves Maxwell's Equations for emitting dipoles of random orientation in a planar multilayer device, O. H. Crawford, J. Chem. Phys. 89, p6017, 1988; K. B. Kahen, Appl. Phys. Lett. 78, p1649, 2001. The dipole emission spectrum is assumed to have equal number of photons from 380 nm wavelength to 780 nm wavelength. This hypothetical emission spectrum was used to ensure that the calculated results are generic and not influenced by the specific selection of emitters. This emission is assumed to occur uniformly in the first 10 nm of the emitting layer bordering the hole-transporting layer. For each layer, the model uses wavelength-dependent complex refractive indices that are either measured by spectroscopic ellipsometry or taken from the literature, Handbook of Optical Constants of Solids, ed. by E. D. Palik, Academic Press, 1985; Handbook of Optical Constants of Solids II, ed. by E. D. Palik, Academic Press, 1991; CRC Handbook of Chemistry and Physics, 83rd ed., edited by D. R. Lide, CRC Press, Boca Raton, 2002. Once the EL spectrum has been derived, it is straightforward to compute the luminance (up to a constant factor) and the CIE chromaticities of this spectrum. Numerous comparisons between predicted EL spectra and measured EL spectra have confirmed that the model predictions are very accurate.

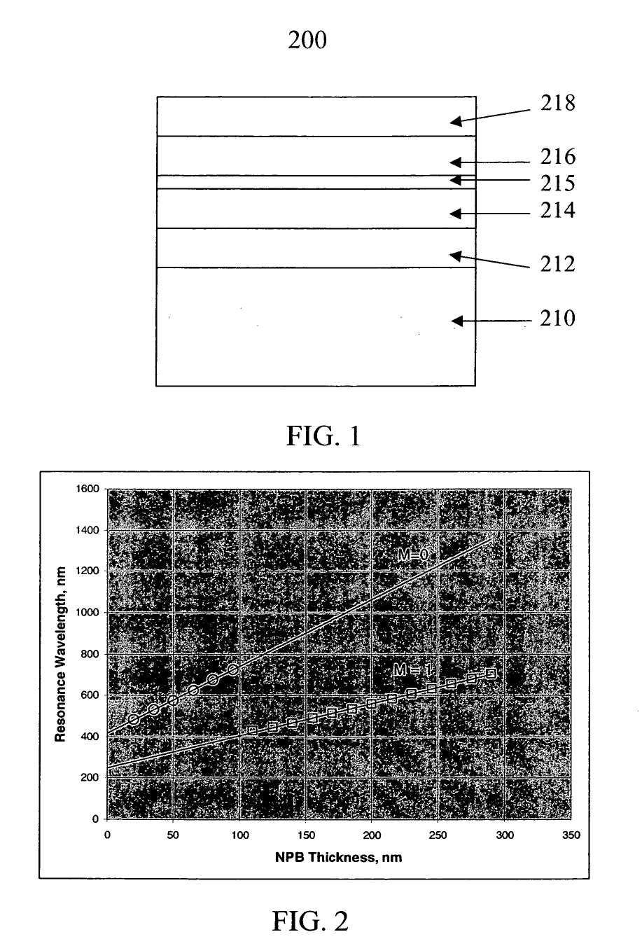

FIG. 1 is a schematic illustration of the cross-sectional structure of a simple bottom emitting microcavity OLED device 200 including a glass substrate 210; a thin Ag layer acting as the semitransparent anode 212; a N,N′-di(naphthalene-1-yl)-N,N′-diphenyl-benzidine (NPB) layer acting as the hole transport layer 214; a light-emitting layer 215; a tris(8-hydroxyquinoline)-aluminum(III) (Alq) layer acting as the electron transport layer 216; and a Ag layer acting as the reflecting cathode 218. The electron transport layer 216, the light-emitting layer 215, and the hole transport layer 214 constitute the organic EL element 230. In practical devices, it is often preferred to have a hole injection layer (not shown) between anode 212 and hole transport layer 214, and an electron injection layer (not shown) between electron transport layer 216 and cathode 218 to facilitate the injection of carriers. In other devices there can be additional function layers such as one or more emissive layers, one or more hole blocking layers, transparent conductive spacer layers, etc. The presence of these additional function layers can be properly accounted for by including their thicknesses and optical properties in the calculation and will not change the substance of the present invention.

FIG. 2 shows the calculated resonance wavelength as a function of the thickness of NPB hole transport layer 214. For this study the following thickness values were used: 20 nm for anode 212; 10 nm for light-emitting layer 215; 50 nm for electron transport layer 216; and 100 nm for cathode layer 218. For the NPB hole transport layer 214 thickness range studied, 0 to 300 nm, the results can be represented by two straight-line segments. The segment with less than 100 nm NPB thickness represents the M=0 cavities in Equation 1. For example, at NPB thickness of 40 nm, corresponding to a total organic thickness of 100 nm, the peak emission wavelength is at 547 nm. The slope of the straight-line segment is 3.23. Thus, for every 1.0 nm change in NPB thickness corresponding to about one percent change in total organic layer thickness, the emission wavelength shifts by 3.23 nm. This is a very noticeable change in color for a very small change in the total organic layer thickness. The segment with NPB thickness larger than 100 nm represents the M=1 cavities in Equation 1. Here at the NPB thickness of 190 nm, corresponding to a total organic layer thickness of 250 nm, the peak emission wavelength is at 548 nm. The slope of this segment of straight-line is 1.56. Thus, for every 2.5 nm change in NPB thickness, corresponding to about one percent change in total organic layer thickness, the emission wavelength shifts by 3.9 nm. This is again a very noticeable change in emission color for a very small change in organic layer thickness. This example illustrates that in order to make microcavity OLED devices with high yield, the layer thickness control needs to be much better than the ˜5% level common in today's manufacturing practices.

Effective ways to measure the thickness of the extremely thin layers used in OLED devices during a manufacturing process, however, are not currently available. OLED devices based on non-polymeric, small molecule organic materials, for example, are typically made using vacuum evaporation process. For vacuum evaporation processes, the common measuring and control system is based on oscillating silicon crystal monitors. Even with all the recent advances in improving the linearity and precision of the devices and methods, however, crystal monitors still do not have the accuracy, stability, and repeatability required to achieve the tolerance needed for reliably fabricating microcavity OLED devices. An alternative proposed method is to use ellipsometric measurements. Although the accuracy, stability, and repeatability of measurement is much improved over the crystal monitor method, the ellipsometric method is expensive, difficult to implement inside a vacuum chamber, and too slow to yield real time feedback information to effectively control the deposition process at a production rate needed for making cost competitive OLED devices. For OLED devices based on polymeric materials, crystal monitors cannot be used, and no other measurement and control system is effective to provide the thickness control needed for fabricating microcavity devices.

Two important discoveries are a result of the present invention:
(1) A critical parameter in determining the performance of a microcavity OLED device performance is the resonance emission wavelength of the microcavity. The resonance emission wavelength is sensitive to the total optical cavity length and not so to the thickness of the individual layers within the cavity. The individual layers can have much bigger variation without having significant impact on the device performance, provided this variation is compensated by variations in other layers such that the total optical cavity length is kept constant; and
(2) The reflectivity spectrum of a microcavity OLED device is a strong function of optical cavity length. The reflective spectrum of a microcavity OLED device is found to show a distinct minimum near its resonance peak emission wavelength. The relationship between the reflectivity minimum wavelength (Rₘᵢₙ) and the resonance or peak emission wavelength (Eₘᵢₙ) is well defined and repeatable. Here the reflectivity is measured off the light-emitting electrode by illuminating the OLED device using a light source outside of the OLED device.

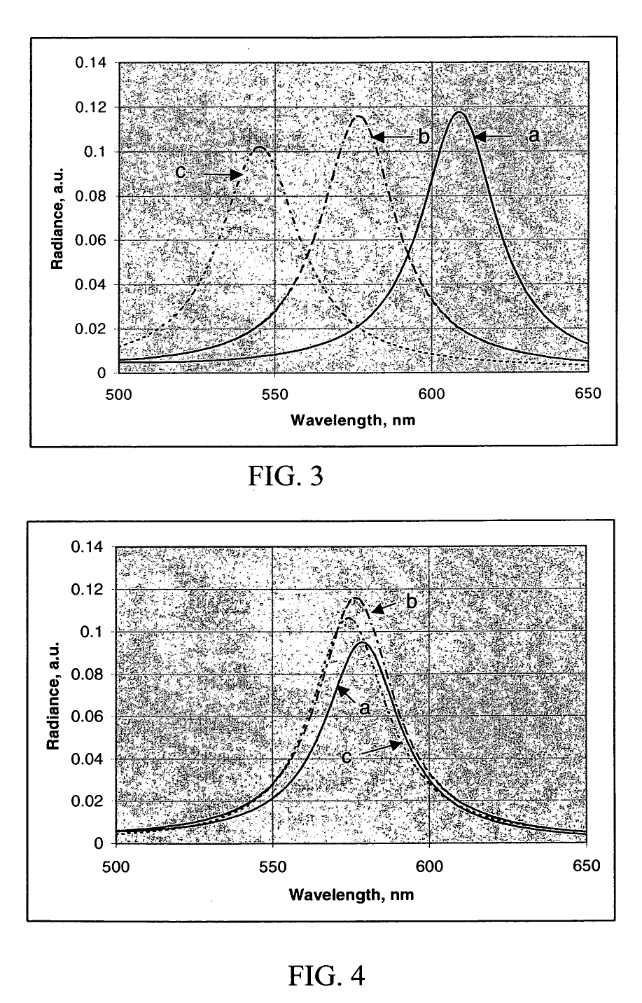

To illustrate the first point, the output spectra of microcavity OLED device 200 were calculated for three thickness values of hole transport layer 214. These spectra were calculated based on the following thickness values for the other layers: 20 nm for anode 212; 10 nm for light-emitting layer 215; 50 nm for electron transport layer 216; and 100 nm for cathode layer 218. As shown in FIG. 3, the emission spectra shifted greatly when hole transport layer 214 thickness was varied from 190 nm to 210 nm to 230 nm. The calculation was then repeated for the same hole transport layer 214 thickness range, but the thickness of electron transport layer 216 was also varied at the same time such that the sum of the thicknesses of electron transport layer 216, and hole transport layer 214 was kept constant at 260 nm. It is clear that the resulting spectra in FIG. 4 showed a much reduced shift in peak position and peak height than those in FIG. 3. These results clearly demonstrated that if the total cavity thickness is maintained, the variation in individual layer thickness is much more tolerable.

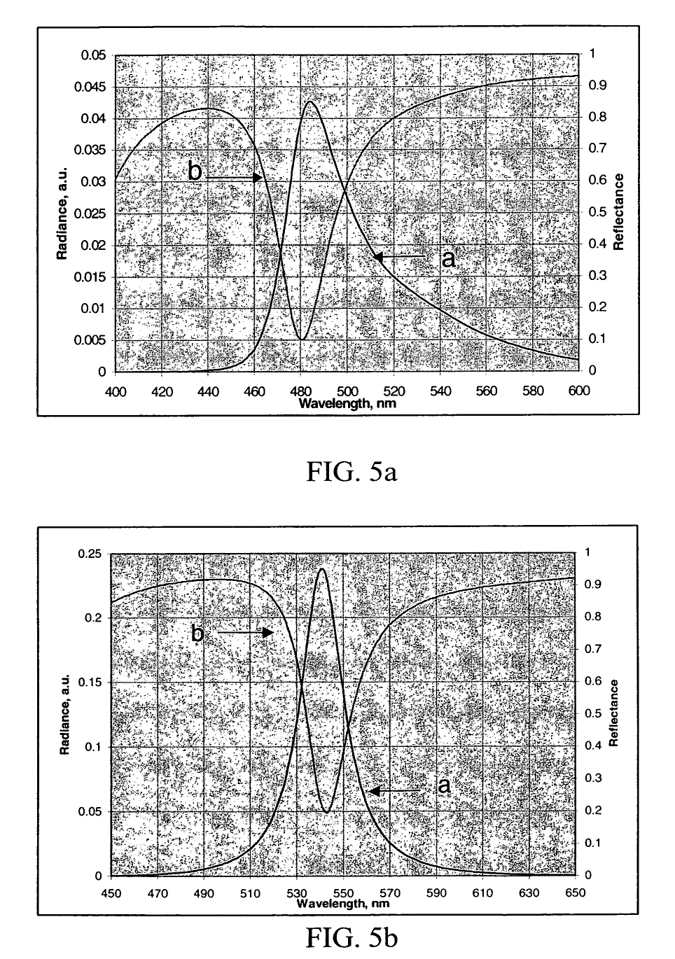

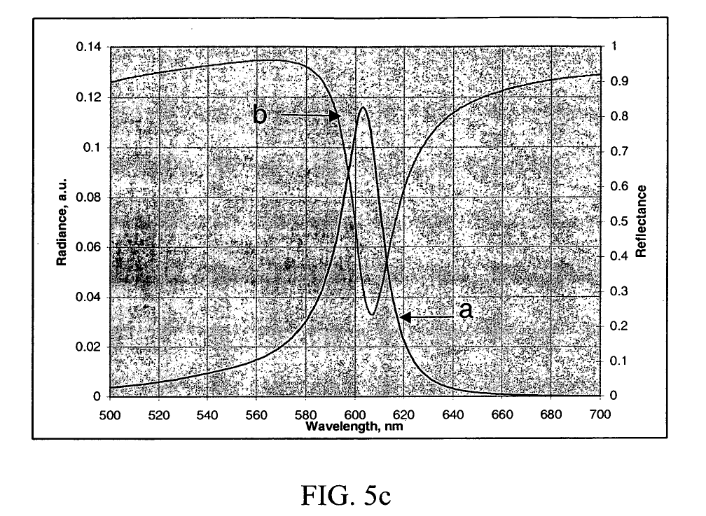

To illustrate the second point, the emission and reflection spectra of three microcavity OLED devices 300a, 300b, 300c were calculated. The structure of these devices is similar to that of microcavity OLED device 200, except that the thickness of NPB hole transport layer 314 were chosen to be 150 nm, 190 nm, and 230 nm, such that the peak emission of these devices are in the blue, green, and red portion of the visible spectrum, respectively. The emission and reflectivity spectra of these three devices are shown in FIG. 5A for the blue device, FIG. 5B for the green device, and FIG. 5C for the red device. In each of these figures, near the peak of the emission spectrum (curve E) the reflectivity spectrum (curve R) shows a distinctive minimum.

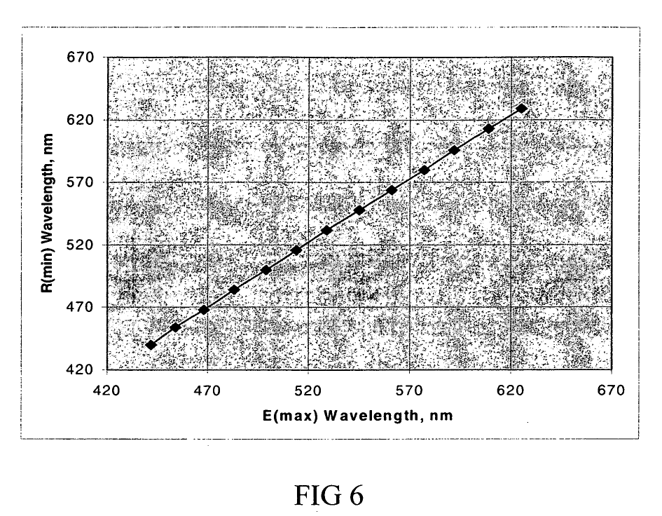

FIG. 6 shows the calculated Rₘᵢₙ and Eₘₐₓ for several additional microcavity devices with different resonance cavity lengths. FIG. 6 shows that there is a clearly defined relationship between the reflective minimum wavelength (Rₘᵢₙ) and the emission maximum wavelength (Eₘₐₓ). Thus, by determining Rₘᵢₙ, it is immediately known whether the Eₘₐₓ is in control. If the Eₘₐₓ is different from the target value, a difference signal can be sent back to the deposition chamber to adjust the thickness of at least one of the layers in a device to be subsequently fabricated to bring its Eₘₐₓ to the target value. This procedure can be used to correct errors not only in layer thickness, but in the optical constants of the materials involved as well.

Thus, in one embodiment of the present invention, a method for monitoring and control the manufacturing process of microcavity OLED device includes the steps of measuring the reflectivity spectrum of a completed microcavity OLED device; determining its reflectivity minimum Rₘᵢₙ; determining the emission maximum Eₘₐₓ using the predetermined relationship between Rₘᵢₙ and Eₘₐₓ; and if the Eₘₐₓ deviates from the target value, adjusting the thickness of at least one of the layers in at least one of the subsequent microcavity OLED devices to bring the Eₘₐₓ of the said subsequent microcavity OLED device to the target value. A completed microcavity OLED device is herein defined as a microcavity OLED device that has both electrodes and the organic EL element already coated.

In another embodiment of the present invention, a target Rₘᵢₙ value is predetermined using the relationship between Rₘᵢₙ and Eₘₐₓ. The method for monitoring and controlling the manufacturing process of microcavity OLED device includes measuring the reflectivity spectrum of a completed microcavity OLED device, determining its reflectivity minimum Rₘᵢₙ, and, if the Rₘᵢₙ deviates from the target value, adjusting the thickness of at least one of the layers in at least one of the subsequent microcavity OLED devices to be fabricated to bring the Rₘᵢₙ of the said subsequent microcavity OLED device to the target value.

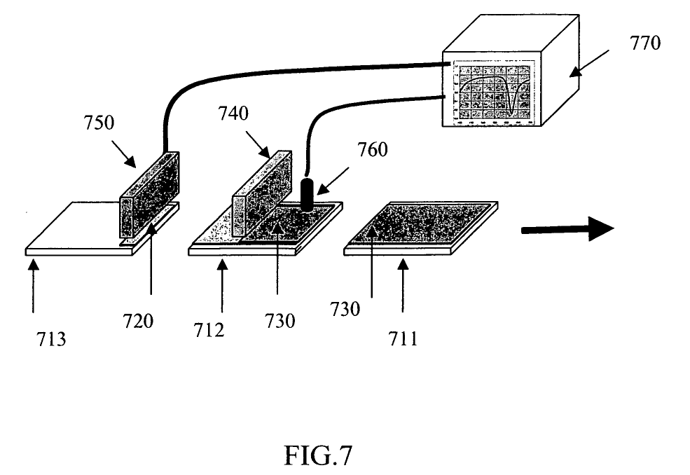

FIG. 7 illustrates one embodiment of the present invention. Substrate 711 is a substrate that has been coated with the complete microcavity OLED structure including the cathode layer 730. Substrate 712 is a subsequent substrate in the manufacturing line. Substrate 712 has already been coated with the anode layer and all the organic layers 720 and is being coated with the cathode layer 730 from source 740. Reflectivity measuring probe 760 is located relative to the completed portion of substrate 712 and is sending the reflectivity data to instrument 770 where the reflectivity minimum is determined and compared with a target value to produce a difference signal. The difference signal is sent to source 750, which is coating the organic layers onto a subsequent substrate 713. Adjustments are made to the coating rate or coating time of source 750 in order to reduce the difference signal for substrate 713.

In accordance with the present invention, the control method can be applied to an active matrix or a passive matrix full color OLED display device having three different colored subpixels using three different colored emitters. Each colored subpixel in this OLED display device uses a different colored emitter and a different cavity length. To control the manufacturing process in accordance with the present invention, reflectivity spectrum measurements are made on each of the three different kinds of colored subpixels. If the individual colored pixels are too small for the reflectivity spectrum to be measured conveniently, designated witness areas on the same substrate of the microcavity OLED device can be used so that the reflectivity measurements can be conveniently made. The deviations between the measured reflectivity minima and the target values are used to produce a difference signal to adjust the thickness of at least one of the layers in each of the pixels to bring the wavelength of reflectivity minima of a subsequent OLED display device in the manufacturing process to the target values.

In accordance with the present invention, the control method can also be applied to an OLED display device using microcavity structure for pixelation, commonly assigned U.S. patent application Ser. No. 10/356,271 filed Jan. 31, 2003 entitled “Color OLED Display with Improved Emission” by Yuan-Sheng Tyan et al., the disclosure of which is herein incorporated by reference. In such devices a common broadband emitting organic EL element is used for all colored pixels. For example, in a microcavity OLED display, there can be a blue, a green, and a red colored subpixel in each pixel of the display. A common broadband emitter is used for all subpixels, and the different colors are achieved by using spacers of different thickness to achieve different cavity length, and hence different resonance emission wavelength for the different colored subpixels. For manufacturing convenience, these spacers are preferably fabricated as part of the back-plane fabrication process. Here a back-plane refers to the substrate for an active matrix microcavity OLED display that has been coated with a thin-film transistor (TFT) array or for a passive matrix microcavity OLED display that has been coated with the column or the row electrodes. In this situation, separate witness areas can be constructed for monitoring all the three subpixels. The Rₘᵢₙ values for all three microcavities can be determined. The three Rₘᵢₙ values can be used to determine whether the relative thickness of the three spacers is made correctly and the information can be used to correct the spacer deposition process. In addition, since the three colored subpixels might have different thickness sensitivity, the measured Rₘᵢₙ values can be used to produce difference signals as feedback to the organic EL element deposition process to bring the Eₘₐₓ of the thickness-sensitive subpixel to the target value.

It is preferable that the measurement of the reflectivity spectrum is done in-situ with minimum time delay between the coating of the cathode layer and the measuring of the reflectivity spectrum. The method can be applied to the fabrication of non-polymeric, small molecular based OLED devices wherein the thin-film layers are fabricated using vacuum deposition techniques or to the fabrication of polymer based OLED devices wherein some of the layers are fabricated by solution processing techniques such as inject, spin, or other coating techniques.

The invention has been described in detail with particular reference to certain preferred embodiments thereof, but it will be understood that variations and modifications can be effected within the spirit and scope of the invention.

### PARTS LIST

200 microcavity OLED device
210 substrate
212 semitransparent anode
214 hole transport layer
214 light-emitting layer
216 electron transport layer
218 reflecting cathode
230 organic EL element
711,712,713 substrates
720 organic layers
730 second electrode layer
740 source
750 source
760 reflectivity measuring probe
770 reflectivity measuring instrument

1. A method for controlling the fabrication of microcavity OLED device, comprising:
a) providing a substrate;
b) forming a microcavity OLED device including two mirror layers and one or more organic layers disposed between the two mirror layers;
c) illuminating the microcavity OLED device and measuring the reflectivity spectrum to determine the wavelength of the reflectivity minimum;
d) comparing the wavelength of the reflectivity minimum to a target value to produce a difference signal; and
e) making adjustments in accordance with the difference signal to the deposition rate or deposition time of at least one of the organic layers in a subsequent OLED device to reduce the difference signal in the subsequent microcavity OLED device.

2. The method according to claim 1 wherein the microcavity OLED device is an active matrix OLED full color display device or a passive matrix OLED full color display device.

3. The method according to claim 2 wherein the reflectivity spectrum of the three colored subpixels is measured either directly in the subpixels or in witness areas designed to simulate the subpixels.

4. The method according to claim 1 wherein the microcavity OLED device is a polymeric or non-polymeric small molecular OLED device.

7. The method according to claim 1 wherein the microcavity OLED device utilizes microcavity structure for pixelation.
